(19) United States
(12) Patent Application Publication
(10) Pub. No.: US 2023/0162507 A1
(43) Pub. Date: May 25, 2023

(54) IMAGE PROCESSING SYSTEM AND IMAGE PROCESSING METHOD

(71) Applicant: TOYOTA JIDOSHA KABUSHIKI KAISHA, Toyota-shi (JP)

(72) Inventors: Masahiro MORI, Nisshin-shi (JP); Takahiro FUJITA, Toyota-shi (JP)

(73) Assignee: TOYOTA JIDOSHA KABUSHIKI KAISHA, Toyota-shi (JP)

(21) Appl. No.: 17/955,890

(22) Filed: Sep. 29, 2022

(30) Foreign Application Priority Data
Nov. 25, 2021 (JP) 2021-190909

(51) Int. Cl. G06V 20/54; G06T 15/30; G06V 20/62; G06V 10/44

(52) U.S. Cl. CPC G06V 20/54; G06T 15/30; G06V 20/625; G06V 10/44

(57) ABSTRACT

An image processing system includes at least one memory configured to store video data, and a processor configured to perform image processing on the video data. The processor is configured to select a preregistered target vehicle from among vehicles included in the video data. The processor is configured to clip, in the video data, a plurality of frames from the video data before the preregistered target vehicle is selected, and generate an image including the target vehicle by using the clipped frames.

### CROSS-REFERENCE TO RELATED APPLICATION

This application claims priority to Japanese Patent Application No. 2021-190909 filed on Nov. 25, 2021, incorporated herein by reference in its entirety.

### BACKGROUND

### 1. Technical Field

The present disclosure relates to an image processing system and an image processing method.

### 2. Description of Related Art

A user who likes to drive may wish to capture an image of his or her moving vehicle. The user can post (upload) the captured image to, for example, a social networking service (hereinafter referred to as “SNS”) so that many people can view the image. However, it is difficult for the user to image the appearance of his/her traveling vehicle while driving the vehicle by himself/herself. In view of this, there has been proposed a service for imaging the appearance of a traveling vehicle. For example, Japanese Unexamined Patent Application Publication No. 2021-48449 (JP 2021-48449 A) discloses a vehicle imaging system.

### SUMMARY

The vehicle imaging system disclosed in JP 2021-48449 A identifies a vehicle based on information for identifying the vehicle, images the identified vehicle, and transmits image data of the imaged vehicle to a communication device. That is, in the vehicle imaging system disclosed in JP 2021-48449 A, the timing when the vehicle can be imaged is limited to the timing after the vehicle has been identified. Therefore, even if there is a photogenic moment (may be period) that meets the user's need before the vehicle is identified, the vehicle imaging system disclosed in JP 2021-48449 A cannot capture the image at such a moment.

The present disclosure has been made to solve the problem described above, and an object of the present disclosure is to enable image capturing at a moment that meets the user's need.

An image processing system according to a first aspect of the present disclosure includes at least one memory configured to store video data captured by a camera, and a processor configured to perform image processing on the video data stored in the memory. The processor is configured to select a preregistered target vehicle from among vehicles included in the video data captured by the camera. The processor is configured to clip, in the video data stored in the memory, a plurality of frames from the video data before the preregistered target vehicle is selected, and generate an image including the target vehicle by using the clipped frames.

In the image processing system according to the first aspect, the processor may be configured to clip all frames from entry of the target vehicle into an imageable range of the camera to exit of the target vehicle from the imageable range.

In the image processing system according to the first aspect, the processor may be configured to clip, in addition to all the frames, a frame before the entry of the target vehicle into the imageable range and a frame after the exit of the target vehicle from the imageable range.

According to such configurations, the processor can clip not only the frames including the target vehicle from the video data after the selection of the target vehicle, but also the frames included in the video data before the selection of the target vehicle. The processor preferably clips all the frames including the target vehicle, and more preferably clips the frames before and after all the frames. According to such configurations, an image including the target vehicle (viewing image described later) can be generated from a series of scenes from the time before the entry of the target vehicle into the imageable range of the camera to the time after the exit of the target vehicle from the imageable range.

In the image processing system according to the first aspect, the memory may include a ring buffer. The ring buffer may include a storage area configured to be able to store newly captured video data by a predetermined amount, and may be configured to automatically delete, from the storage area, old video data that exceeds the predetermined amount.

In the image processing system according to the first aspect, the processor may be configured to select the target vehicle based on license codes of license plates of the vehicles included in the video data.

In the image processing system according to the first aspect, the memory may be configured to store a license code recognition model. The license code recognition model may be a trained model configured to receive an input of a video including a license code of a license plate, and output the license code in the video. The processor may be configured to recognize the license codes from the video data captured by the camera by using the license code recognition model.

According to such configurations, the target vehicle can be selected with high accuracy by recognizing the license code.

In the image processing system according to the first aspect, the processor may be configured to select the target vehicle based on pieces of identification information of communication devices mounted on the vehicles.

In the image processing system according to the first aspect, the memory may be configured to store a vehicle extraction model. The vehicle extraction model may be a trained model configured to receive an input of a video including a vehicle, and output the vehicle in the video. The processor may be configured to extract a plurality of vehicles including the target vehicle from the video data captured by the camera by using the vehicle extraction model.

According to such configurations, the vehicles including the target vehicle can be extracted with high accuracy.

In the image processing system according to the first aspect, the processor may be configured to extract a feature amount of the target vehicle. The processor may be configured to identify a vehicle having the feature amount from among the vehicles included in the video data, and clip a frame including the identified vehicle and a frame including the target vehicle.

In the image processing system according to the first aspect, the memory may be configured to store a target vehicle identification model. The target vehicle identification model may be a trained model configured to receive an input of a video from which a vehicle is extracted, and output the vehicle in the video. The processor may be configured to identify the vehicle having the feature amount from the video data captured by the camera based on the target vehicle identification model.

According to such configurations, the vehicle having the same feature amount as that of the target vehicle can be identified with high accuracy from the video data.

An image processing method according to a second aspect of the present disclosure includes causing a memory to store video data showing vehicles imaged by a camera, selecting a preregistered target vehicle from among the vehicles included in the video data captured by the camera, clipping, in the video data stored in the memory, a plurality of frames from the video data before the preregistered target vehicle is selected, and generating an image including the target vehicle by using the clipped frames.

According to the present disclosure, it is possible to capture the image at the moment that meets the user's need.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of an image processing system according to a first embodiment;

FIG. 2 is a block diagram showing a typical hardware configuration of an imaging system according to the first embodiment;

FIG. 3 is a diagram showing how a camera images a vehicle;

FIG. 4 is a block diagram showing a typical hardware configuration of a server;

FIG. 5 is a diagram for describing how a vehicle is imaged in an image processing system according to a comparative example;

FIG. 6 is a functional block diagram showing functional configurations of the imaging system and the server according to the first embodiment;

FIG. 7 is a diagram for describing processes to be executed by a matching process unit and a target vehicle selection unit;

FIG. 8 is a diagram for describing an example of a trained model (vehicle extraction model) to be used in a vehicle extraction process;

FIG. 9 is a diagram for describing an example of a trained model (number recognition model) to be used in a number recognition process;

FIG. 10 is a diagram for describing an example of a trained model (target vehicle identification model) to be used in a target vehicle identification process;

FIG. 11 is a flowchart showing a processing procedure of vehicle imaging according to the first embodiment;

FIG. 12 is a block diagram showing a typical hardware configuration of an imaging system according to a second embodiment;

FIG. 13 is a functional block diagram showing a functional configuration of the imaging system according to the second embodiment; and

FIG. 14 is a flowchart showing a processing procedure of vehicle imaging according to the second embodiment.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### First Embodiment

### System Configuration

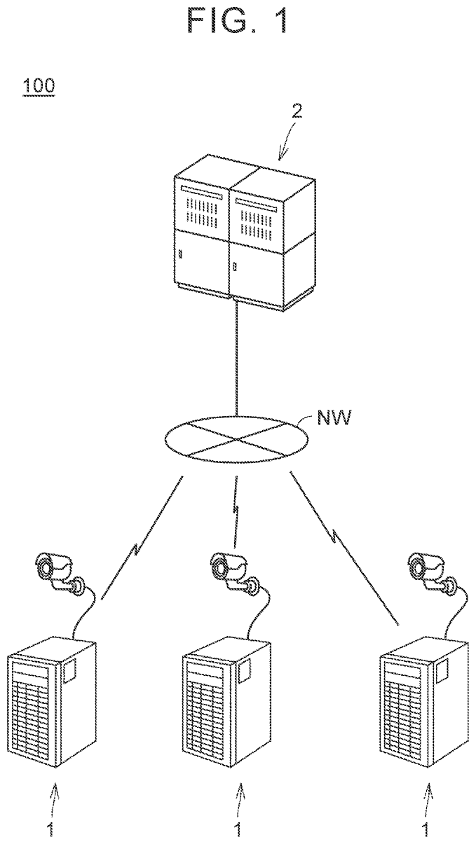

FIG. 1 is a diagram schematically showing an overall configuration of an image processing system according to a first embodiment of the present disclosure. An image processing system 100 includes a plurality of imaging systems 1 and a server 2. The imaging systems 1 and the server 2 are communicably connected to each other via a network NW. Although three imaging systems 1 are shown in FIG. 1, the number of imaging systems 1 is not particularly limited. Only one imaging system 1 may be provided.

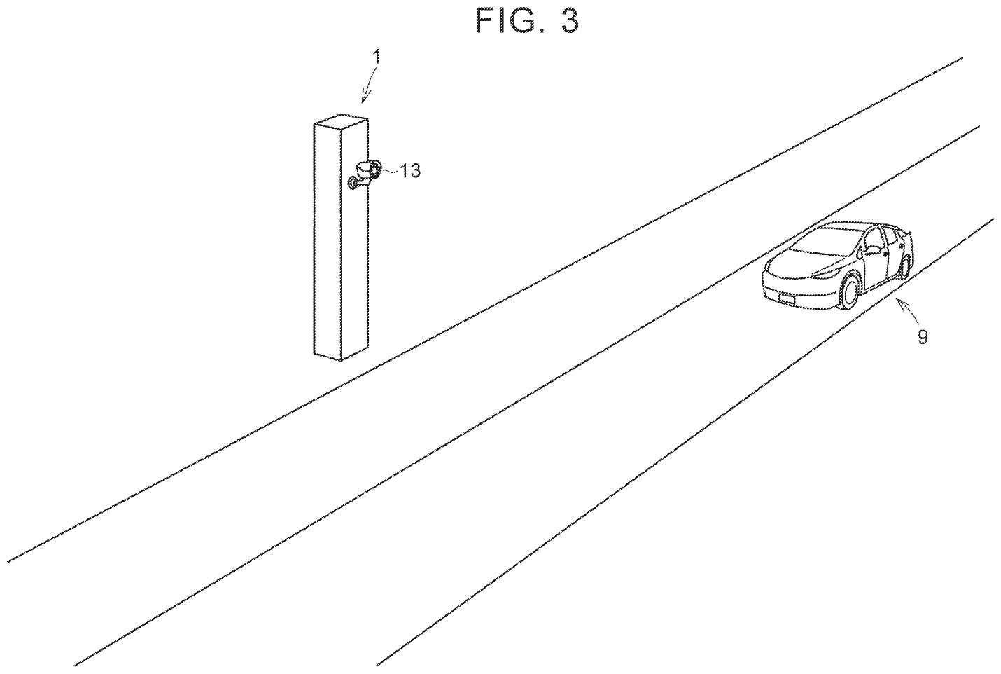

The imaging system 1 is installed, for example, near a road and images a vehicle 9 (see FIG. 3) traveling on the road. In the present embodiment, the imaging system 1 performs a predetermined arithmetic process (described later) on a captured video, and transmits a result of the arithmetic process to the server 2 together with the video.

The server 2 is, for example, an in-house server of a business operator that provides a vehicle imaging service. The server 2 may be a cloud server provided by a cloud server management company. The server 2 generates an image to be viewed by a user (hereinafter referred to also as “viewing image”) from a video received from the imaging system 1, and provides the generated viewing image to the user. The viewing image is generally a still image, but may be a video for a specified period (for example, a short period of about several seconds). In many cases, the user is a driver of the vehicle 9, but is not particularly limited.

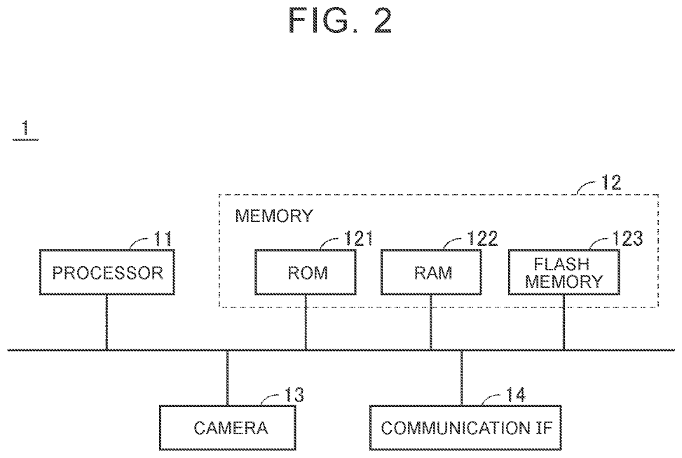

FIG. 2 is a block diagram showing a typical hardware configuration of the imaging system 1 according to the first embodiment. The imaging system 1 includes a processor 11, a memory 12, a camera 13, and a communication interface (IF) 14. The memory 12 includes a read only memory (ROM) 121, a random access memory (RAM) 122, and a flash memory 123. The components of the imaging system 1 are connected to each other by a bus or the like.

The processor 11 controls the overall operation of the imaging system 1. The memory 12 stores programs (operating system and application programs) to be executed by the processor 11, and data (maps, tables, mathematical expressions, parameters, etc.) to be used in the programs. The memory 12 temporarily stores a video captured by the imaging system 1.

The camera 13 captures a video of the vehicle 9. The camera 13 is preferably a high-sensitivity camera with a polarizing lens.

FIG. 3 is a diagram showing how the camera 13 images a vehicle. The camera 13 can image a license plate on the vehicle 9, and can also image a vehicle body of the vehicle 9. The video captured by the camera 13 is used not only for recognizing a license plate number but also for generating a viewing image.

Referring back to FIG. 2, the communication IF 14 is an interface for communicating with the server 2. The communication IF 14 is, for example, a communication module compliant with 4th generation (4G) or 5G.

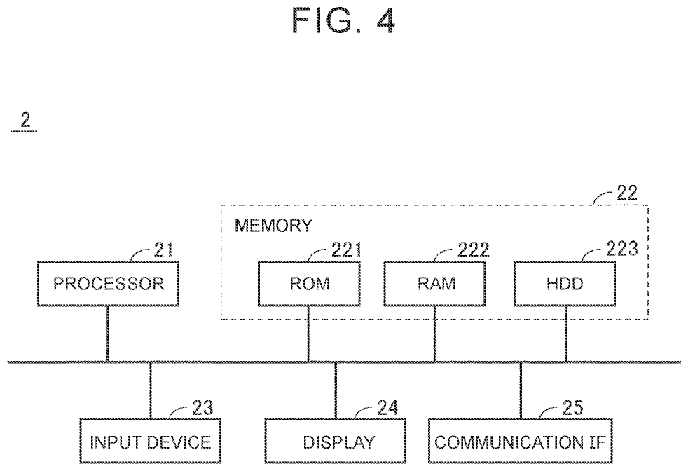

FIG. 4 is a block diagram showing a typical hardware configuration of the server 2. The server 2 includes a processor 21, a memory 22, an input device 23, a display 24, and a communication IF 25. The memory 22 includes a ROM 221, a RAM 222, and a hard disk drive (HDD) 223. The components of the server 2 are connected to each other by a bus or the like.

The processor 21 executes various arithmetic processes in the server 2. The memory 22 stores programs to be executed by the processor 21, and data to be used in the programs. The memory 22 stores data to be used for image processing by the server 2, and data subjected to the image processing by the server 2. The input device 23 receives an input from an administrator of the server 2. The input device 23 is typically a keyboard and a mouse. The display 24 displays various types of information. The communication IF 25 is an interface for communicating with the imaging system 1.

### Comparative Example

An image processing system 900 according to a comparative example will be described to facilitate understanding of the features of the image processing system 100 according to the present embodiment.

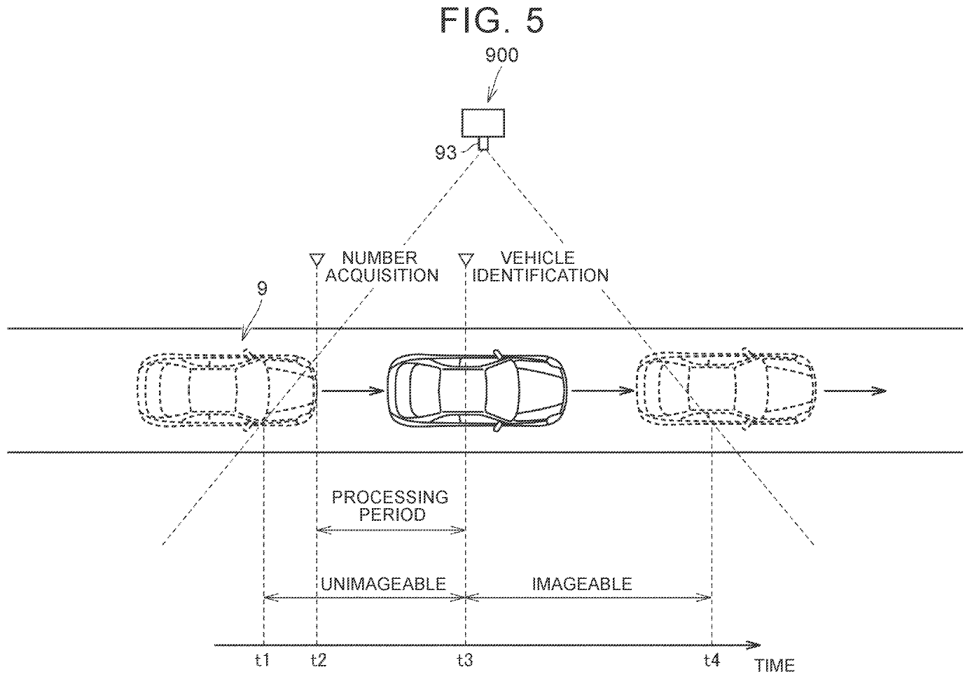

FIG. 5 is a diagram for describing how a vehicle is imaged in the image processing system 900 according to the comparative example. It is assumed that a vehicle 9 traveling from left to right is imaged by a camera 93. Dashed lines extending from the camera 93 indicate an imageable range of the camera 93.

At a time t1, the distal end of the vehicle 9 enters the imageable range. At this time, the license plate is out of the imageable range. At a time t2, the license plate enters the imageable range and is imaged. It takes some processing period for the processor to recognize the number and determine whether the vehicle 9 is a vehicle to be imaged (hereinafter referred to also as “target vehicle”). During that period as well, the vehicle 9 is traveling. At a time t3, the vehicle 9 is identified as the target vehicle. A period from the time t3 to a time t4 when the vehicle 9 exits the imageable range is an imageable period for the vehicle 9 in the comparative example.

In this case, even if there is a photogenic moment (or period) that meets the user's need before the time t3 when the vehicle 9 is identified, the image cannot be captured at such a moment. It is not even possible to image a stream of scenes from the entry of the vehicle 9 into the imageable range to the exit of the vehicle 9 from the imageable range.

In the present embodiment, a video before the time t3 when the vehicle 9 is identified is also stored in the memory 22. In the present embodiment, the stream of scenes from the entry of the vehicle 9 into the imageable range to the exit of the vehicle 9 from the imageable range is imaged and then a part or all of the stream is clipped. This makes it possible to capture an image at the moment that meets the user's need.

The vehicle 9 is not limited to a four-wheel vehicle shown in FIG. 5, and may be, for example, a two-wheel vehicle (motorcycle). Since the license plate of the two-wheel vehicle is attached only to the rear, the period required until the license plate is imaged and the vehicle is identified is likely to be longer than that for the four-wheel vehicle. Therefore, the effect of the image processing system 100 in that the image is captured at the moment that meets the user's need is more remarkable for motorcycles.

### Functional Configuration of Image Processing System

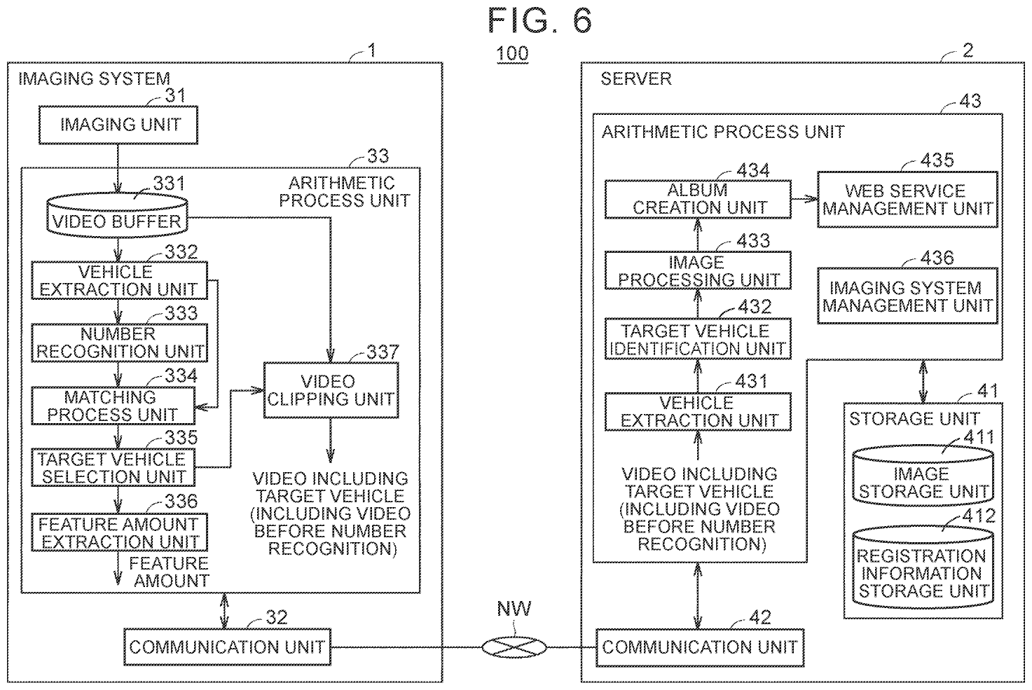

FIG. 6 is a functional block diagram showing functional configurations of the imaging system 1 and the server 2 according to the first embodiment. The imaging system 1 includes an imaging unit 31, a communication unit 32, and an arithmetic process unit 33. The arithmetic process unit 33 includes a video buffer 331, a vehicle extraction unit 332, a number recognition unit 333, a matching process unit 334, a target vehicle selection unit 335, a feature amount extraction unit 336, and a video clipping unit 337.

The imaging unit 31 captures a video of the vehicle 9 and outputs the captured video to the video buffer 331. The imaging unit 31 corresponds to the camera 13 in FIG. 2.

The communication unit 32 performs bidirectional communication with a communication unit 42 (described later) of the server 2 via the network NW. The communication unit 32 receives the number of the target vehicle from the server 2 and transmits the number of each vehicle imaged by the imaging unit 31 to the server. The communication unit 32 transmits a video (more specifically, a video clip including the target vehicle) to the server 2. The communication unit 32 corresponds to the communication IF 14 in FIG. 2.

The video buffer 331 temporarily stores the video captured by the imaging unit 31. The video buffer 331 is typically a ring buffer (circular buffer), and has an annular storage area in which the beginning and the end of a one-dimensional array are logically connected to each other. A newly captured video is stored in the video buffer 331 by a predetermined amount (may be a predetermined number of frames or a predetermined period) that can be stored in the storage area. An old video that exceeds the predetermined period is automatically deleted from the video buffer 331. The video buffer 331 outputs the video to the vehicle extraction unit 332 and the video clipping unit 337.

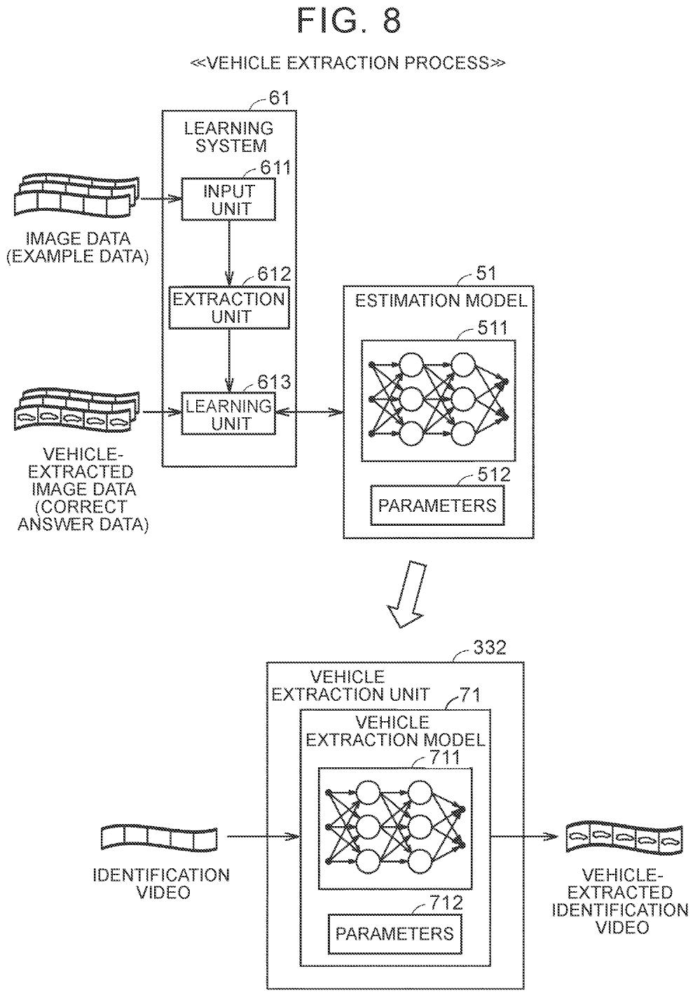

The vehicle extraction unit 332 extracts a vehicle (not only the target vehicle but vehicles as a whole) from the video. This process is referred to also as “vehicle extraction process”. For example, a trained model generated by a machine learning technology such as deep learning can be used for the vehicle extraction process. In this example, the vehicle extraction unit 332 is implemented by a “vehicle extraction model”. The vehicle extraction model will be described with reference to FIG. 8. The vehicle extraction unit 332 outputs a part of the video from which a vehicle is extracted (frame including a vehicle) to the number recognition unit 333 and the matching process unit 334.

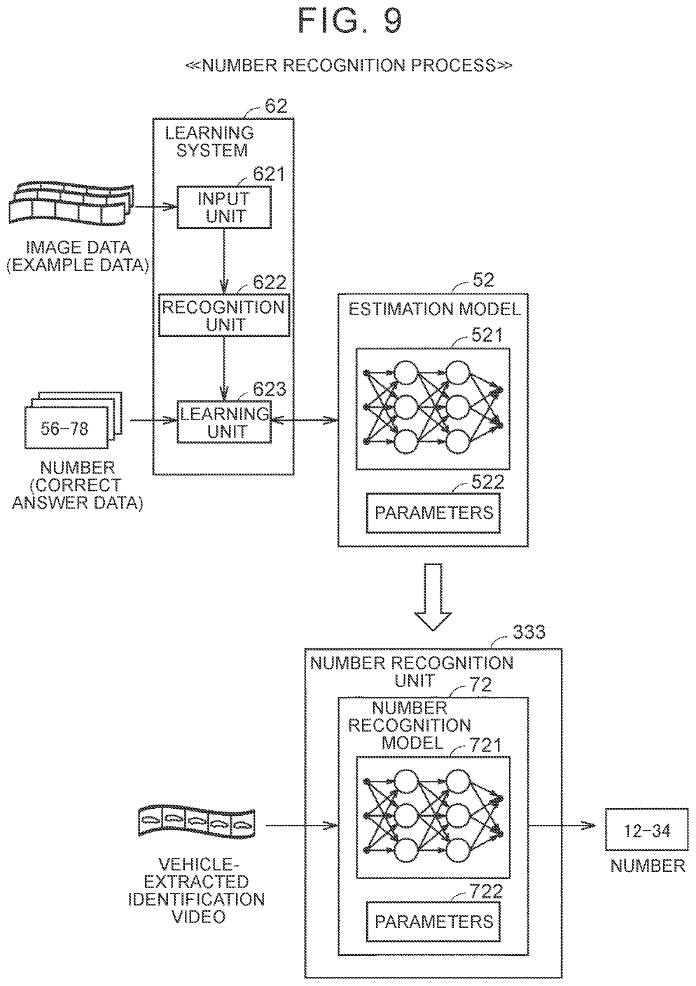

The number recognition unit 333 recognizes a license plate number in the part from which the vehicle is extracted by the vehicle extraction unit 332 (frame including the vehicle). This process is referred to also as “number recognition process”. A trained model generated by a machine learning technology such as deep learning can be used also for the number recognition process. In this example, the number recognition unit 333 is implemented by a “number recognition model”. The number recognition model will be described with reference to FIG. 9. The number recognition unit 333 outputs the recognized number to the matching process unit 334. The number recognition unit 333 outputs the recognized number also to the communication unit 32. As a result, the number of each vehicle is transmitted to the server 2. The “number” in the present embodiment is an example of a “license code” described in “SUMMARY”. The “license code” is not limited to the “number”.

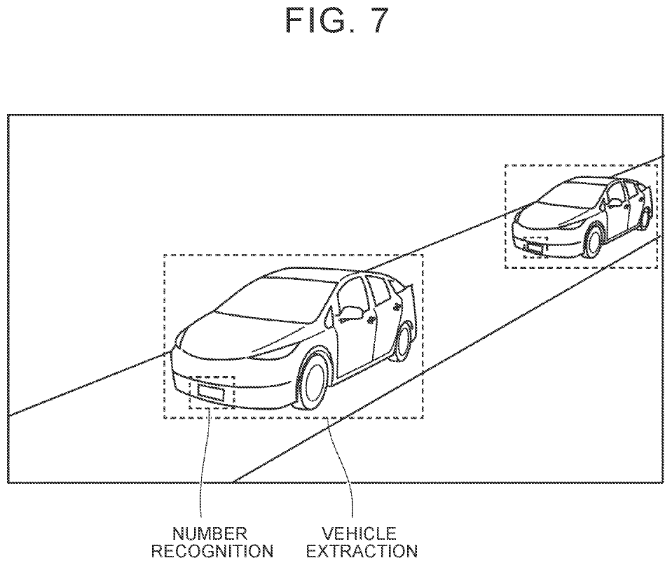

FIG. 7 is a diagram for describing processes to be executed by the matching process unit 334 and the target vehicle selection unit 335. Description will be given of an exemplary situation in which two vehicles are extracted by the vehicle extraction unit 332 and two numbers are recognized by the number recognition unit 333. The matching process unit 334 associates the vehicle extracted by the vehicle extraction unit 332 with the number recognized by the number recognition unit 333 (matching process). More specifically, the matching process unit 334 calculates, for each number, a distance between the number and each vehicle (distance between coordinates of the number and coordinates of each vehicle on the frame). Then, the matching process unit 334 associates the number with a vehicle having a shorter distance from the number. The matching process unit 334 outputs results of the matching process, that is, the vehicles associated with the numbers to the target vehicle selection unit 335.

The target vehicle selection unit 335 selects, as the target vehicle, a vehicle whose number matches the number of the target vehicle (received from the server 2) from among the vehicles associated with the numbers by the matching process. The target vehicle selection unit 335 outputs the vehicle selected as the target vehicle to the feature amount extraction unit 336 and the video clipping unit 337.

Referring to FIG. 6 again, the feature amount extraction unit 336 extracts a feature amount of the target vehicle by analyzing the video including the target vehicle. The feature amount may include a traveling condition and an appearance of the target vehicle. More specifically, the feature amount extraction unit 336 calculates a traveling speed of the target vehicle based on a temporal change of the target vehicle in the frames including the target vehicle (for example, an amount of movement of the target vehicle between the frames or an amount of change in the size of the target vehicle between the frames). The feature amount extraction unit 336 may calculate, for example, an acceleration (deceleration) of the target vehicle in addition to the traveling speed of the target vehicle. The feature amount extraction unit 336 extracts information on the appearance (body shape, body color, etc.) of the target vehicle by using a known image recognition technology. The feature amount extraction unit 336 outputs the feature amount (traveling speed, acceleration, body shape, body color, etc.) of the target vehicle to the video clipping unit. The feature amount extraction unit 336 outputs the feature amount of the target vehicle also to the communication unit 32. As a result, the feature amount of the target vehicle is transmitted to the server 2.

The video clipping unit 337 clips a part including the target vehicle from the video stored in the video buffer 331. The video clipping unit 337 preferably clips all the frames including the target vehicle selected by the target vehicle selection unit 335. More preferably, the video clipping unit 337 clips, in addition to all the frames including the target vehicle, a predetermined number of frames before those frames (frames before the entry of the target vehicle into the imageable range of the imaging unit 31) and a predetermined number of frames after those frames (frames after the exit of the target vehicle from the imageable range of the imaging unit 31). That is, the video clipping unit 337 preferably clips a video stream from the time before the entry of the target vehicle into the imageable range of the imaging unit 31 to the time after the exit of the target vehicle from the imageable range. The video clipping unit 337 outputs the clipped video to the communication unit 32. As a result, the video showing the traveling target vehicle over the entire imageable range of the imaging unit 31 is transmitted to the server 2.

The video clipping unit 337 may clip the video by using the feature amount extracted by the feature amount extraction unit 336. For example, the video clipping unit 337 may change the length of the video clipping period depending on the traveling speed of the target vehicle. In other words, the video clipping unit 337 may variably set the numbers (“predetermined numbers”) of frames before and after all the frames including the target vehicle. The video clipping unit 337 can increase the video clipping period as the traveling speed of the target vehicle decreases. As a result, it is possible to more securely clip the video of the traveling target vehicle over the entire imageable range.

The server 2 includes a storage unit 41, the communication unit 42, and an arithmetic process unit 43. The storage unit 41 includes an image storage unit 411 and a registration information storage unit 412. The arithmetic process unit 43 includes a vehicle extraction unit 431, a target vehicle identification unit 432, an image processing unit 433, an album creation unit 434, a web service management unit 435, and an imaging system management unit 436.

The image storage unit 411 stores a viewing image obtained as a result of an arithmetic process by the server 2. More specifically, the image storage unit 411 stores images before and after processing by the image processing unit 433, and an album created by the album creation unit 434.

The registration information storage unit 412 stores registration information related to the vehicle imaging service. The registration information includes personal information of a user who applied for the provision of the vehicle imaging service, and vehicle information of the user. The personal information of the user includes, for example, information on an identification number (ID), a name, a date of birth, an address, a telephone number, and an e-mail address of the user. The vehicle information of the user includes information on a license plate number of the vehicle. The vehicle information may include, for example, information on a vehicle model, a model year, a body shape (sedan, wagon, van, etc.), and a body color.

The communication unit 42 performs bidirectional communication with the communication unit 32 of the imaging system 1 via the network NW. The communication unit 42 transmits the number of the target vehicle to the imaging system 1 and receives the number of each vehicle imaged by the imaging system 1. The communication unit 42 receives a video including the target vehicle and a feature amount (traveling condition and appearance) of the target vehicle from the imaging system 1. The communication unit 42 corresponds to the communication IF 25 in FIG. 4.

The vehicle extraction unit 431 extracts a vehicle (not only the target vehicle but vehicles as a whole) from the video. In this process, a vehicle extraction model can be used similarly to the vehicle extraction process by the vehicle extraction unit 332 of the imaging system 1. The vehicle extraction unit 431 outputs a video from which a vehicle is extracted in the video (frame including a vehicle) to the target vehicle identification unit 432.

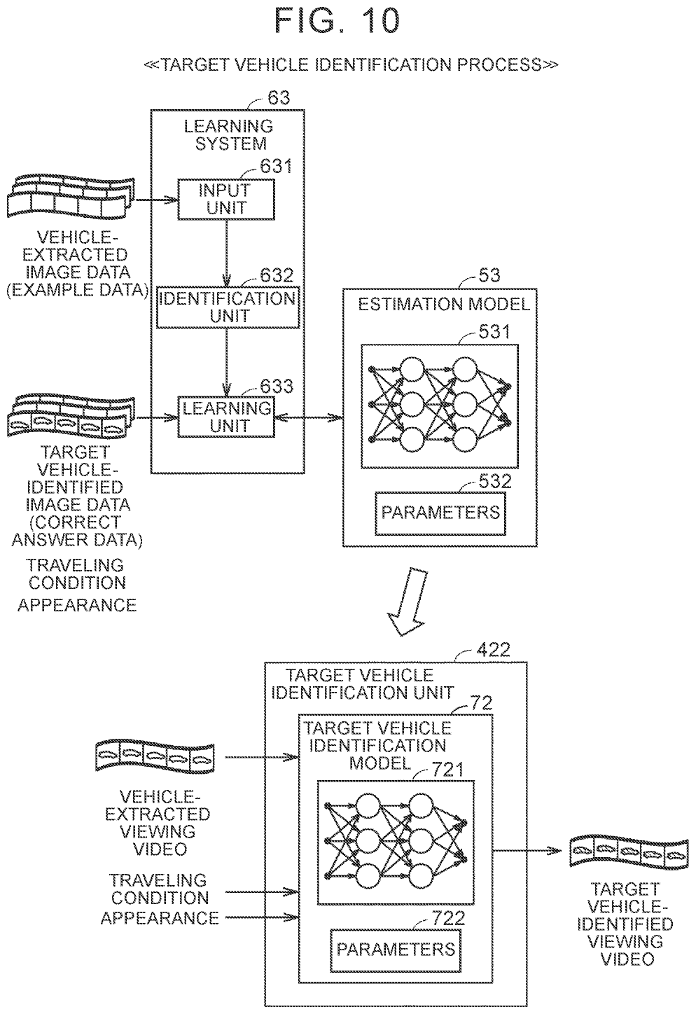

The target vehicle identification unit 432 identifies the target vehicle from among the vehicles extracted by the vehicle extraction unit 431 based on the feature amount of the target vehicle (the traveling condition such as a traveling speed and an acceleration, and the appearance such as a body shape and a body color). This process is referred to also as “target vehicle identification process”. A trained model generated by a machine learning technology such as deep learning can be used also for the target vehicle identification process. In this example, the target vehicle identification unit 432 is implemented by a “target vehicle identification model”. The target vehicle identification will be described with reference to FIG. 10. A viewing image is generated by identifying the target vehicle by the target vehicle identification unit 432. The viewing image normally includes a plurality of images (a plurality of frames continuous in time). The target vehicle identification unit 432 outputs the viewing image to the image processing unit 433.

The image processing unit 433 processes the viewing image. For example, the image processing unit 433 selects a most photogenic image (so-called best shot) from among the plurality of images. Then, the image processing unit 433 performs various types of image correction (trimming, color correction, distortion correction, etc.) on the extracted viewing image. The image processing unit 433 outputs the processed viewing image to the album creation unit 434.

The album creation unit 434 creates an album by using the processed viewing image. A known image analysis technology (for example, a technology for automatically creating a photo book, a slide show, or the like from images captured by a smartphone) can be used for creating the album. The album creation unit 434 outputs the album to the web service management unit 435.

The web service management unit 435 provides a web service (for example, an application program that can be linked to an SNS) using the album created by the album creation unit 434. The web service management unit 435 may be implemented on a server different from the server 2.

The imaging system management unit 436 manages (monitors and diagnoses) the imaging system 1. In the event of some abnormality (camera failure, communication failure, etc.) in the imaging system 1 under management, the imaging system management unit 436 notifies the administrator of the server 2 about the abnormality. As a result, the administrator can take measures such as inspection or repair of the imaging system 1. The imaging system management unit 436 may be implemented as a separate server similarly to the web service management unit 435.

### Trained Models

FIG. 8 is a diagram for describing an example of the trained model (vehicle extraction model) to be used in the vehicle extraction process. An estimation model 51 that is a pre-learning model includes, for example, a neural network 511 and parameters 512. The neural network 511 is a known neural network to be used for an image recognition process by deep learning. Examples of the neural network include a convolution neural network (CNN) and a recurrent neural network (RNN). The parameters 512 include a weighting coefficient and the like to be used in arithmetic operations by the neural network 511.

A large amount of teaching data is prepared in advance by a developer. The teaching data includes example data and correct answer data. The example data is image data including a vehicle to be extracted. The correct answer data includes an extraction result associated with the example data. Specifically, the correct answer data is image data including the vehicle extracted from the example data.

A learning system 61 trains the estimation model 51 by using the example data and the correct answer data. The learning system 61 includes an input unit 611, an extraction unit 612, and a learning unit 613.

The input unit 611 receives a large amount of example data (image data) prepared by the developer, and outputs the data to the extraction unit 612.

By inputting the example data from the input unit 611 into the estimation model 51, the extraction unit 612 extracts a vehicle included in the example data for each piece of example data. The extraction unit 612 outputs the extraction result (output from the estimation model 51) to the learning unit 613.

The learning unit 613 trains the estimation model 51 based on the vehicle extraction result from the example data that is received from the extraction unit 612 and the correct answer data associated with the example data. Specifically, the learning unit 613 adjusts the parameters 512 (for example, the weighting coefficient) so that the vehicle extraction result obtained by the extraction unit 612 approaches the correct answer data.

The estimation model 51 is trained as described above, and the trained estimation model 51 is stored in the vehicle extraction unit 332 (and the vehicle extraction unit 431) as a vehicle extraction model 71. The vehicle extraction model 71 receives an input of a video, and outputs a video from which a vehicle is extracted. The vehicle extraction model 71 outputs, for each frame of the video, the extracted vehicle in association with an identifier of the frame to the matching process unit 334. The frame identifier is, for example, a time stamp (time information of the frame).

FIG. 9 is a diagram for describing an example of the trained model (number recognition model) to be used in the number recognition process. Example data is image data including a number to be recognized. Correct answer data is data indicating a position and a number of a license plate included in the example data. Although the example data and the correct answer data are different, the learning method for an estimation model 52 by a learning system 62 is the same as the learning method by the learning system 61 (see FIG. 8). Therefore, detailed description is not repeated.

The trained estimation model 52 is stored in the number recognition unit 333 as a number recognition model 72. The number recognition model 72 receives an input of a video from which a vehicle is extracted by the vehicle extraction unit 332, and outputs coordinates and a number of a license plate. The number recognition model 72 outputs, for each frame of the video, the recognized coordinates and number of the license plate in association with an identifier of the frame to the matching process unit 334.

FIG. 10 is a diagram for describing an example of the trained model (target vehicle identification model) to be used in the target vehicle identification process. Example data is image data including a target vehicle to be identified. The example data further includes information on a feature amount (specifically, a traveling condition and appearance) of the target vehicle. Correct answer data is image data including the target vehicle identified in the example data. The learning method for an estimation model 53 by a learning system 63 is the same as the learning methods by the learning systems 61 and 62 (see FIGS. 8 and 9). Therefore, detailed description is not repeated.

The trained estimation model 53 is stored in the target vehicle identification unit 432 as a target vehicle identification model 73. The target vehicle identification model 73 receives an input of a video from which a vehicle is extracted by the vehicle extraction unit 431 and a feature amount (traveling condition and appearance) of the target vehicle, and outputs a video including the identified target vehicle. The target vehicle identification model 73 outputs, for each frame of the video, the identified video in association with an identifier of the frame to the image processing unit 433.

The vehicle extraction process is not limited to the process using the machine learning. A known image recognition technology (image recognition model or algorithm) that does not use the machine learning can be applied to the vehicle extraction process. The same applies to the number recognition process and the target vehicle identification process.

### Processing Flow

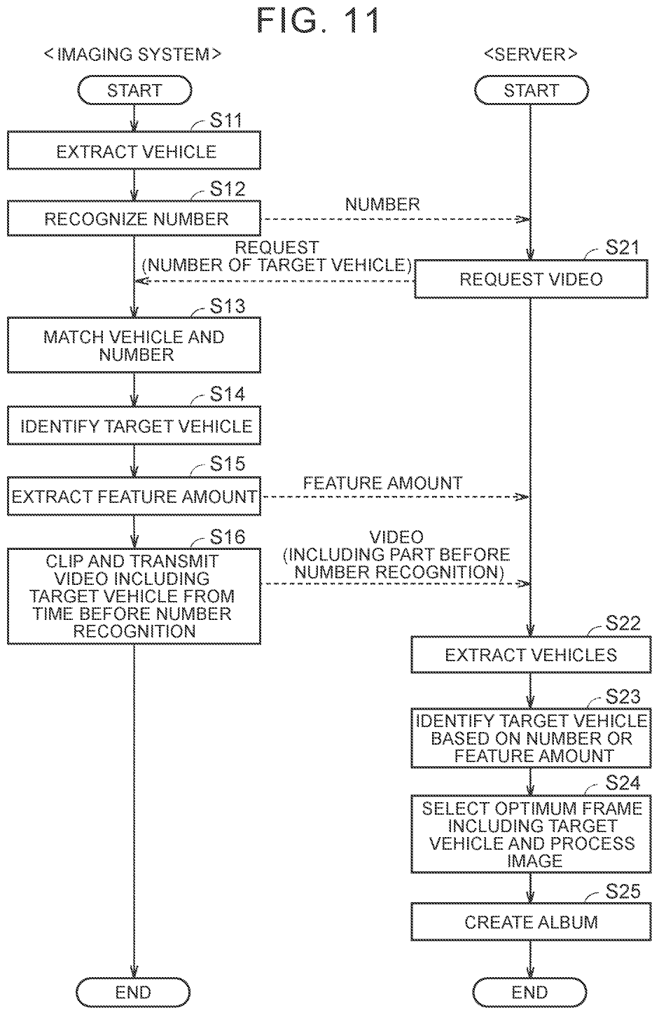

FIG. 11 is a flowchart showing a processing procedure of the vehicle imaging according to the first embodiment. This flowchart is executed, for example, when a predetermined condition is satisfied or at a predetermined cycle. In FIG. 11, the process performed by the imaging system 1 is shown on the left side, and the process performed by the server 2 is shown on the right side. Each step is realized by software processing by the processor 11 of the imaging system 1 or the processor 21 of the server 2, but may be realized by hardware (electric circuit). Hereinafter, the step is abbreviated as “S”.

In S11, the imaging system 1 extracts a vehicle by executing the vehicle extraction process (see FIG. 8) for a video. The imaging system 1 recognizes a number by executing the number recognition process (see FIG. 9) for the video from which the vehicle is extracted (S12). The imaging system 1 transmits the recognized number to the server 2.

When the number is received from the imaging system 1, the server 2 refers to registration information to determine whether the received number is a registered number (that is, the vehicle imaged by the imaging system 1 is a vehicle of a user who applied for the provision of the vehicle imaging service (target vehicle)). When the received number is the registered number (the number of the target vehicle), the server 2 transmits the number of the target vehicle and requests the imaging system 1 to transmit a video including the target vehicle (S21).

In S13, the imaging system 1 executes the matching process between each vehicle and each number in the video. Then, the imaging system 1 selects, as the target vehicle, a vehicle associated with the same number as the number of the target vehicle from among the vehicles associated with the numbers (S14). The imaging system 1 extracts a feature amount (traveling condition and appearance) of the target vehicle, and transmits the extracted feature amount to the server 2 (S15).

In S16, the imaging system 1 clips, from the video temporarily stored in the memory 22 (video buffer 331), a part including the target vehicle from a time before the number recognition (before the selection of the target vehicle). Since the clipping method has been described in detail in FIG. 6, the description will not be repeated. The imaging system 1 transmits the clipped video to the server 2.

In S22, the server 2 extracts vehicles by executing the vehicle extraction process (see FIG. 8) for the video received from the imaging system 1.

In S23, the server 2 identifies the target vehicle from among the vehicles extracted in S22 based on the feature amount (traveling condition and appearance) of the target vehicle (target vehicle identification process in FIG. 10). It is also conceivable to use only one of the traveling condition and the appearance of the target vehicle as the feature amount of the target vehicle. However, the video may include a plurality of vehicles having the same body shape and body color, or may include a plurality of vehicles having substantially the same traveling speed and acceleration. In the present embodiment, the target vehicle can be distinguished from the other vehicles when the traveling speed and/or the acceleration are/is different among the vehicles even if the video includes the vehicles having the same body shape and body color. Alternatively, the target vehicle can be distinguished from the other vehicles when the body shape and/or the body color are/is different among the vehicles even if the video includes the vehicles having substantially the same traveling speed and acceleration. By using both the traveling condition and the appearance of the target vehicle as the feature amount of the target vehicle, the accuracy of the target vehicle identification can be improved.

It is not essential to use both the traveling condition and the appearance of the target vehicle, and only one of them may be used. The information on the traveling condition and/or the appearance of the target vehicle corresponds to “target vehicle information” according to the present disclosure. The information on the appearance of the target vehicle is not limited to the vehicle information obtained by the analysis performed by the imaging system 1 (feature amount extraction unit 336), but may be vehicle information prestored in the registration information storage unit 412.

In S24, the server 2 selects an optimum viewing image (best shot) from the video (plurality of viewing images) including the target vehicle. The server 2 performs image correction on the optimum viewing image. Then, the server 2 creates an album by using the corrected viewing image (S25). The user can view the created album and post a desired image in the album to the SNS.

As described above, in the first embodiment, the imaging system 1 selects the target vehicle by the recognition of the license plate number. Then, the imaging system 1 clips all the frames including the target vehicle (including the frames before the selection of the target vehicle) and transmits the frames to the server 2. More preferably, the imaging system 1 additionally clips the frames before and after all the frames including the target vehicle and transmits the frames to the server 2. As a result, the server 2 collects a stream of scenes from the time before the entry of the target vehicle into the imageable range of the camera 13 to the time after the exit of the target vehicle from the imageable range. Therefore, the server 2 can select the optimum frame from the stream of scenes and generate the viewing image. According to the first embodiment, it is possible to capture the image at the moment that meets the user's need.

### Second Embodiment

In the first embodiment, description has been given of the configuration in which the target vehicle is identified by using the license plate number. The method for identifying the target vehicle is not limited to this method. In a second embodiment, the target vehicle is identified by using a wireless communication identification number.

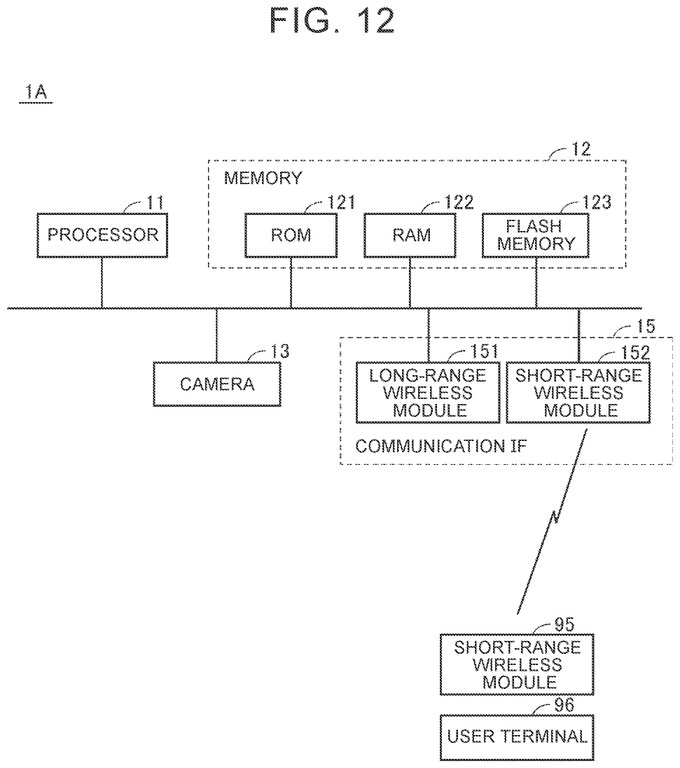

FIG. 12 is a block diagram showing a typical hardware configuration of an imaging system 1A according to the second embodiment. The imaging system 1A differs from the imaging system 1 (see FIG. 2) of the first embodiment in that a communication IF 15 is provided in place of the communication IF 14. The communication IF 15 includes a long-range wireless module 151 and a short-range wireless module 152.

The long-range wireless module 151 is, for example, a communication module compliant with 4G or 5G similarly to the communication IF 14. The long-range wireless module 151 is used for long-range communication between the imaging system 1A and the server 2.

The short-range wireless module 152 is a communication module compliant with short-range communication standards such as Wi-Fi (registered trademark) or Bluetooth (registered trademark). The short-range wireless module 152 communicates with a short-range wireless module 95 provided in the vehicle 9 and with a user terminal 96 (smartphone, tablet terminal, etc.) of the user of the vehicle 9.

The short-range wireless module 95 of the vehicle 9 and the user terminal 96 have identification numbers (referred to also as “device addresses”) unique to the respective wireless devices compliant with the short-range communication standards. The short-range wireless module 152 of the imaging system 1A can acquire the identification number of the short-range wireless module 95 and/or the identification number of the user terminal 96.

The short-range wireless module 95 and the user terminal 96 are hereinafter referred to also as “wireless devices” comprehensively. The identification number of the wireless device is referred to also as “wireless device ID”. The wireless device ID of the target vehicle is acquired in advance from the user (for example, when applying for the vehicle imaging service) and stored in the registration information storage unit 412 (see FIG. 6).

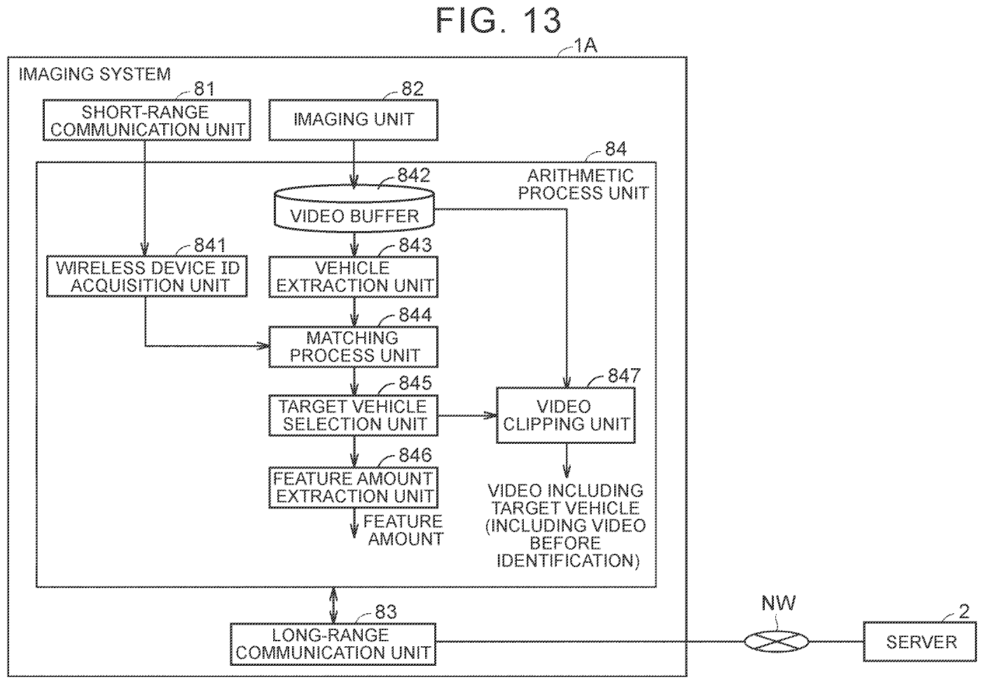

FIG. 13 is a functional block diagram showing a functional configuration of the imaging system 1A according to the second embodiment. The imaging system 1A includes a short-range communication unit 81, an imaging unit 82, a long-range communication unit 83, and an arithmetic process unit 84. The arithmetic process unit 84 includes a wireless device ID acquisition unit 841, a video buffer 842, a vehicle extraction unit 843, a matching process unit 844, a target vehicle selection unit 845, a feature amount extraction unit 846, and a video clipping unit 847.

The short-range communication unit 81 performs short-range communication with the wireless device mounted on the vehicle 9. The short-range communication unit 81 corresponds to the short-range wireless module 152 in FIG. 12.

The wireless device ID acquisition unit 841 acquires the identification number (wireless device ID) of the short-range wireless module 95 and/or the identification number of the user terminal 96. The wireless device ID acquisition unit 841 outputs the acquired wireless device ID to the matching process unit 844.

The imaging unit 82, the video buffer 842, and the vehicle extraction unit 843 are equivalent to the imaging unit 31, the video buffer 331, and the vehicle extraction unit 332 (see FIG. 6) in the first embodiment, respectively.

The matching process unit 844 associates the vehicle extracted by the vehicle extraction unit 843 with the wireless device ID acquired by the wireless device ID acquisition unit 841 (matching process). More specifically, the matching process unit 844 associates, at a timing when the vehicle including the wireless device has approached, the wireless device ID acquired from the wireless device with the vehicle extracted by the vehicle extraction unit 843. As the vehicle 9 approaches the imaging system 1A, the strength of the short-range wireless communication is improved. Therefore, the matching process unit 844 may associate the vehicle with the wireless device ID based on the strength of the short-range wireless communication in addition to the wireless device ID. The matching process unit 844 outputs a result of the matching process (the vehicle associated with the wireless device ID) to the target vehicle selection unit 845.

The target vehicle selection unit 845 selects, as the target vehicle, a vehicle whose wireless device ID matches the wireless device ID of the target vehicle (received from the server 2) from among the vehicles associated with the wireless device IDs by the matching process. The target vehicle selection unit 845 outputs the vehicle selected as the target vehicle to the feature amount extraction unit 846 and the video clipping unit 847.

The feature amount extraction unit 846, the video clipping unit 847, and the long-range communication unit 83 are equivalent to the feature amount extraction unit 336, the video clipping unit 337, and the communication unit 32 (see FIG. 6) in the first embodiment, respectively. The server 2 is basically equivalent to the server 2 in the first embodiment. Therefore, the functional block diagram (see FIG. 6) of the server 2 is not shown due to space limitation.

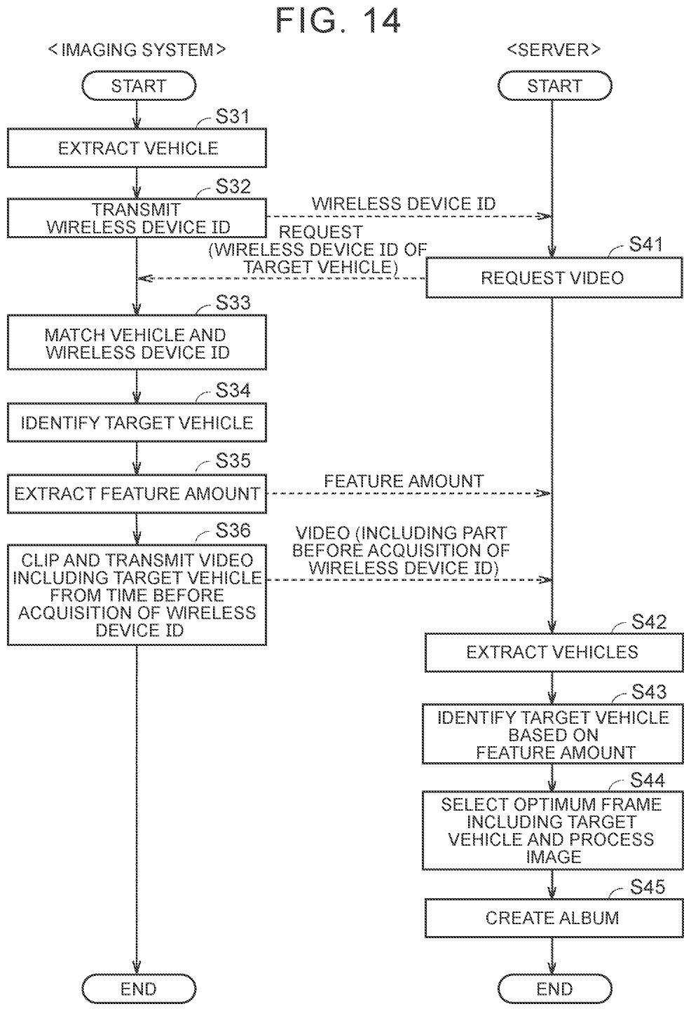

FIG. 14 is a flowchart showing a processing procedure of the vehicle imaging according to the second embodiment. This flowchart is equivalent to the flowchart in the first embodiment (FIG. 11) except that the wireless device ID is used in place of the license plate number. Therefore, the description will not be repeated.

As described above, in the second embodiment, the imaging system 1A selects the target vehicle by using the identification number (wireless device ID) of the short-range wireless module 95 mounted on the vehicle 9 and/or the identification number of the user terminal 96. Then, the imaging system 1A clips all the frames including the target vehicle (including the frames before the selection of the target vehicle) and transmits the frames to the server 2. More preferably, the imaging system 1A additionally clips the frames before and after all the frames including the target vehicle and transmits the frames to the server 2. As a result, the server 2 collects a stream of scenes from the time before the entry of the target vehicle into the imageable range of the camera 13 to the time after the exit of the target vehicle from the imageable range. Therefore, the server 2 can select the optimum frame from the stream of scenes and generate the viewing image. According to the second embodiment, it is possible to capture the image at the moment that meets the user's need.

In the first and second embodiments, description has been given of the example in which the imaging system 1 or 1A and the server 2 share the execution of the image processing. Therefore, both the processor 11 of the imaging system 1 or 1A and the processor 21 of the server 2 correspond to a “processor” according to the present disclosure. The imaging system 1 or 1A may execute all the image processing and transmit the image-processed data (viewing image) to the server 2. Therefore, the server 2 is not an essential component for the image processing according to the present disclosure. In this case, the processor 11 of the imaging system 1 or 1A corresponds to the “processor” according to the present disclosure.

The embodiments disclosed herein should be considered to be illustrative and not restrictive in all respects. The scope of the present disclosure is shown by the claims rather than by the above description of the embodiments, and is intended to include all modifications within the meaning and scope equivalent to the claims.

What is claimed is:

1. An image processing system comprising:
at least one memory configured to store video data captured by a camera; and
a processor configured to
perform image processing on the video data stored in the memory,
select a preregistered target vehicle from among vehicles included in the video data captured by the camera,
clip, in the video data stored in the memory, a plurality of frames from the video data before the preregistered target vehicle is selected, and
generate an image including the target vehicle by using the clipped frames.

2. The image processing system according to claim 1, wherein the processor is configured to clip all frames from entry of the target vehicle into an imageable range of the camera to exit of the target vehicle from the imageable range.

3. The image processing system according to claim 2, wherein the processor is configured to clip, in addition to all the frames, at least one frame before the entry of the target vehicle into the imageable range and at least one frame after the exit of the target vehicle from the imageable range.

4. The image processing system according to claim 1, wherein:
the memory includes a ring buffer; and
the ring buffer includes a storage area configured to be able to store newly captured video data by a predetermined amount, and is configured to automatically delete, from the storage area, old video data that exceeds the predetermined amount.

5. The image processing system according to claim 1, wherein the processor is configured to select the target vehicle based on license codes of license plates of the vehicles included in the video data.

6. The image processing system according to claim 5, wherein:
the memory is configured to store a license code recognition model; and
the license code recognition model is a trained model configured to receive an input of a video including a license code of a license plate, and output the license code in the video; and
the processor is configured to recognize the license codes from the video data captured by the camera by using the license code recognition model.

7. The image processing system according to claim 1, wherein the processor is configured to select the target vehicle based on pieces of identification information of communication devices mounted on the vehicles.

8. The image processing system according to claim 1, wherein:
the memory is configured to store a vehicle extraction model; and
the vehicle extraction model is a trained model configured to receive an input of a video including a vehicle, and output the vehicle in the video; and
the processor is configured to extract a plurality of vehicles including the target vehicle from the video data captured by the camera by using the vehicle extraction model.

9. The image processing system according to claim 1, wherein the processor is configured to:
extract a feature amount of the target vehicle;
identify a vehicle having the feature amount from among the vehicles included in the video data; and
clip a frame including the identified vehicle and a frame including the target vehicle.

10. The image processing system according to claim 9, wherein:
the memory is configured to store a target vehicle identification model; and
the target vehicle identification model is a trained model configured to receive an input of a video from which a vehicle is extracted, and output the vehicle in the video; and
the processor is configured to identify the vehicle having the feature amount from the video data captured by the camera based on the target vehicle identification model.

11. An image processing method comprising:
causing a memory to store video data showing vehicles imaged by a camera;
selecting a preregistered target vehicle from among the vehicles included in the video data captured by the camera;
clipping, in the video data stored in the memory, a plurality of frames from the video data before the preregistered target vehicle is selected; and
generating an image including the target vehicle by using the clipped frames.
